(19) United States
(12) Patent Application Publication
(10) Pub. No.: US 2015/0223639 A1
(43) Pub. Date: Aug. 13, 2015

(54) BARBECUE HEAT PLATE ASSEMBLY HAVING HEAT PLATE WITH CO-PLANAR HEAT DISTRIBUTION ELEMENT

(71) Applicant: WINNERS PRODUCTS ENGINEERING CANADA LTD., Toronto (CA)

(72) Inventors: James HOU, Toronto (CA); Melanie DESOUZA, Toronto (CA); James CASEY, Toronto (CA)

(21) Appl. No.: 14/618,105

(22) Filed: Feb. 10, 2015

Related U.S. Application Data
(60) Provisional application No. 61/939,078, filed on Feb. 12, 2014.

(51) Int. Cl. A47J 37/06; A47J 37/07

(52) U.S. Cl. CPC A47J 37/067; A47J 37/0786

(57) ABSTRACT

A heat plate assembly having a barbecue heat plate with one or more substantially co-planar heat distribution elements. By orientating the plate in the barbecue in a V-shape, and by combining the effects of ceramic stones with a heat plate, substantial even heat distribution can be provided.

### TECHNICAL FIELD

The following relates generally to a heating element and more specifically to a heating element comprising one or more ceramic inserts and suitable for use in a barbecue.

### BACKGROUND

There are many variations of heat plates for barbecues in many different dimensions and shapes. Several such heat plates are triangular (having two sides formed of metal separated by an open base, generally) and are disposed within the barbeque with their apex facing upward. This is generally for diverting grease dripping onto the apex outward toward the sides of the gas element below, which is intended to prevent the grease from contacting the flame, which in turn reduces flare-ups.

Many such heat plates sacrifice the even distribution of heat in order to reduce flare-ups. Alternatively, in place of or in conjunction with the heat plates, large quantities of relatively more expensive stones are used to distribute heat evenly.

### SUMMARY

In one aspect, a heat plate assembly for a barbecue is provided, the heat plate assembly comprising a heat plate having one or more apertures disposed therethrough, each aperture adapted to form a housing for a heat distribution element, and a retainer detachably fastenable to the heat plate to maintain the heat distribution element in the housing, the heat plate having a generally V-shaped profile and the heat distribution element, when housed in the housing, being substantially co-planar with the heat plate, the heat plate disposable within a barbecue such that the apex of the V-shaped profile is disposed towards a heating element of the barbecue.

In embodiments, the heat distribution element is retained in coplanar arrangement with the heat plate.

In embodiments, the aperture of the heat plate slightly smaller in length and width than the heat distribution element to reduce or eliminate any air gap between the heat plate and the heat distribution element.

In embodiments, the heat distribution element is a ceramic stone.

In embodiments, the ceramic stone is ported.

In embodiments, the retainer is detachably fastened to the heat plate by a fastener comprising one or more of clips, screws, magnets, ties, and a cotter pin.

In embodiments, the retainer comprises apertures matching those of the heat plate to retain the heat distribution elements with upper and lower exposed surfaces.

In embodiments, the retainer is fastened to the heat plate to retain to permit the heat plate assembly to be disposed in upside-down orientation within the barbecue while retaining the heat distribution elements therein.

In embodiments, the apex of the heat plate assembly is a collection area for collecting grease during cooking.

In embodiments, the heat plate comprises one row of four apertures to either side of the apex.

In embodiments, the heat distribution elements are elongate.

In embodiments, the heat distribution elements are side-loaded into housings formed by the heat plate and retainer, the housing being accessible along the edges of the heat plate.

In embodiments, the heat distribution elements are rods.

In embodiments, the heat plate assembly comprises one or more grease draining ports along its apex.

In embodiments, the heat plate assembly, when exposed to heat along a lower surface thereof, provides even distribution of heat at the cooking surface of the barbecue.

### DESCRIPTION OF THE DRAWINGS

The following will be described with reference to the drawings, wherein:

FIG. 1 illustrates a barbecue equipped with a plurality of exemplary heat plate assemblies;

FIG. 2 is an exploded bottom perspective view of an exemplary heat plate assembly;

FIG. 3 is a close-up view of one exemplary heat plate assembly disposed within a barbecue;

FIG. 4 is a top perspective view of an exemplary ceramic stone;

FIG. 5 is a side view of the heat plate assembly showing heat distribution and grease collection;

FIG. 6 is another embodiment of the heat plate assembly;

FIG. 7 is another embodiment of the heat plate assembly;

FIG. 8 is another embodiment of the heat plate assembly;

FIG. 9 is another embodiment of the heat plate assembly;

FIG. 10 is another embodiment of the heat plate assembly;

FIG. 11 is another embodiment of the heat plate assembly;

FIG. 12 is another embodiment of the heat plate assembly;

FIG. 13 is another embodiment of the heat plate assembly;

FIG. 14 is another embodiment of the heat plate assembly;

FIG. 15 is another embodiment of the heat plate assembly;

FIG. 16 is a top view of another embodiment of the heat plate assembly;

FIG. 17 is a bottom view of the heat plate assembly shown in FIG. 16;

FIG. 18 is a side view of the heat plate assembly shown in FIG. 16;

FIG. 19 is a front or rear view of the heat plate assembly shown in FIG. 16;

FIG. 20 is a top perspective view of the heat plate assembly shown in FIG. 16;

FIG. 21 is an exploded view of the heat plate assembly shown in FIG. 16;

FIG. 22 is a top view of another embodiment of the heat plate assembly;

FIG. 23 is a bottom view of the heat plate assembly shown in FIG. 22;

FIG. 24 is a side view of the heat plate assembly shown in FIG. 22;

FIG. 25 is a front or rear view of the heat plate assembly shown in FIG. 22;

FIG. 26 is a top perspective view of the heat plate assembly shown in FIG. 22; and

FIG. 27 is an exploded view of the heat plate assembly shown in FIG. 22.

### DETAILED DESCRIPTION

The following provides a heat plate assembly comprising a barbecue heat plate with one or more substantially co-planar heat distribution elements. The heat distribution elements are described herein as being ceramic stones but could be any suitable medium.

The plate provides a hybrid radiant system that combines the benefits of ported ceramic stones and a durable and effective radiant. The heat plate may comprise stainless steel.

While many of the prior proposed heat plates are designed to reduce flare-up in the location of grease drippings, they have the consequence of reducing the even distribution of heat. The following, conversely, prevents flames from coming into direct contact with food and delivers substantially more even temperature distribution.

Applicant has now found that by reversing the orientation of the plate in the barbecue, and by combining the effects of ceramic stones with a heat plate, substantially even distribution of heat can be provided. The plate offers substantial benefits in respect of even distribution of heat at the cooking surface along a large range of temperature requirements. In other words, a barbecue equipped with the plate assembly described herein would generally have reduced hot and cold spots.

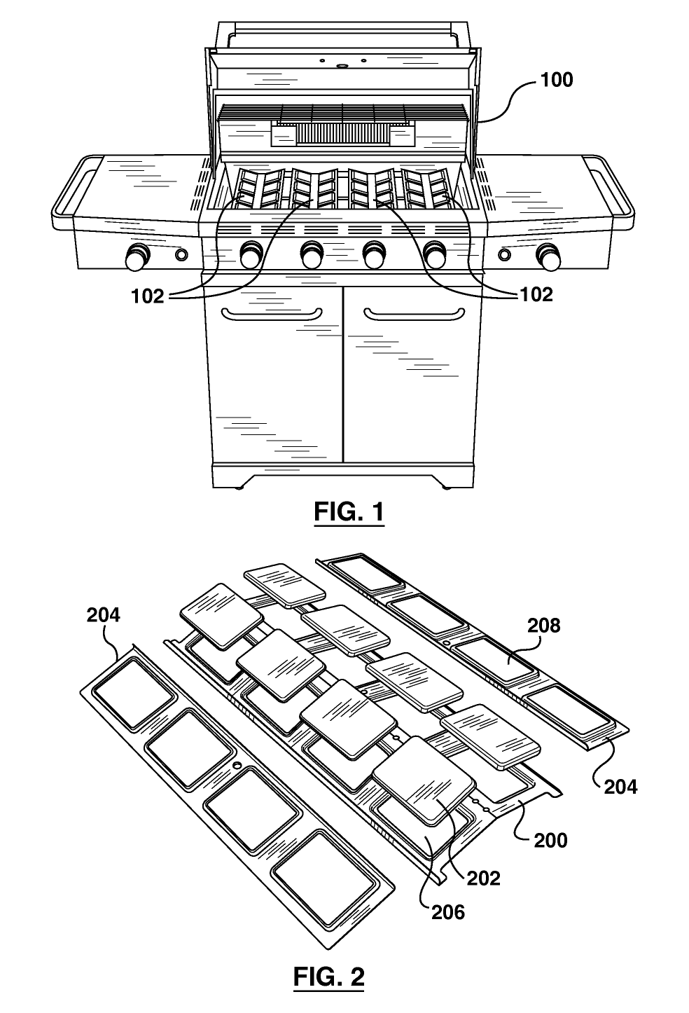

Referring first to FIG. 1, an exemplary barbecue (100) is shown in which four heat plate assemblies (102) are disposed in a side-by-side arrangement. The assemblies (102) are shown disposed longitudinally, which will be the typical orientation; however they could be disposed laterally, or, if the barbecue has multiple cooking zones, some could be longitudinal and some lateral. As can be seen in FIG. 1, the heat plate assemblies (102) are, in aggregate, sized suitably to cover a substantial majority of the surface area of the barbecue's cooking area. It will be appreciated this is not generally the case with most typical triangular heat plates, which are typically intentionally narrow and disposed directly above the gas flame element.

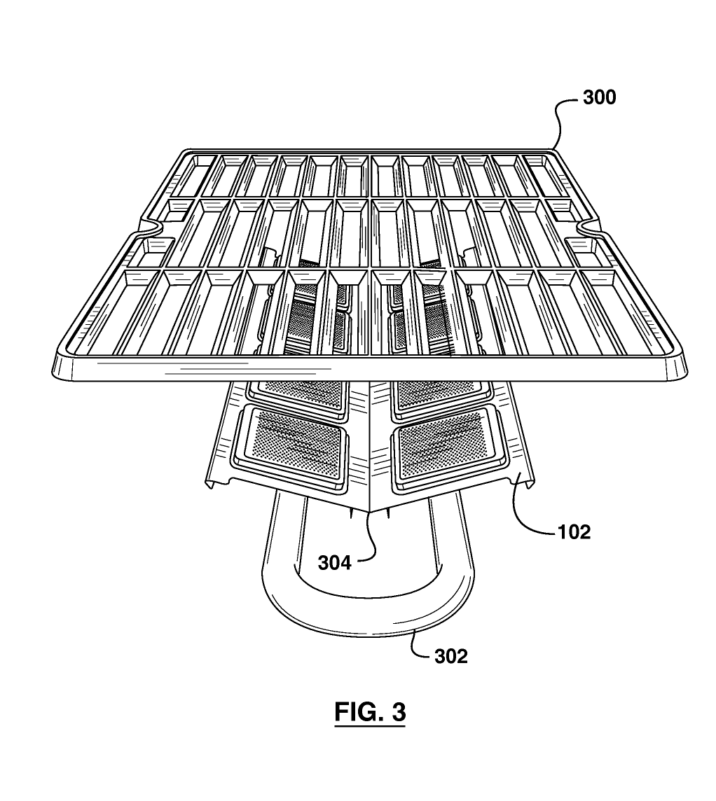

It will be appreciated that the cooking surface (typically a grill) is not shown in FIG. 1. FIG. 3 shows a close-up view of the grill (300) disposed above an exemplary heat plate assembly (102), which itself is disposed above a heating element (302), in this case a gas flame heating element.

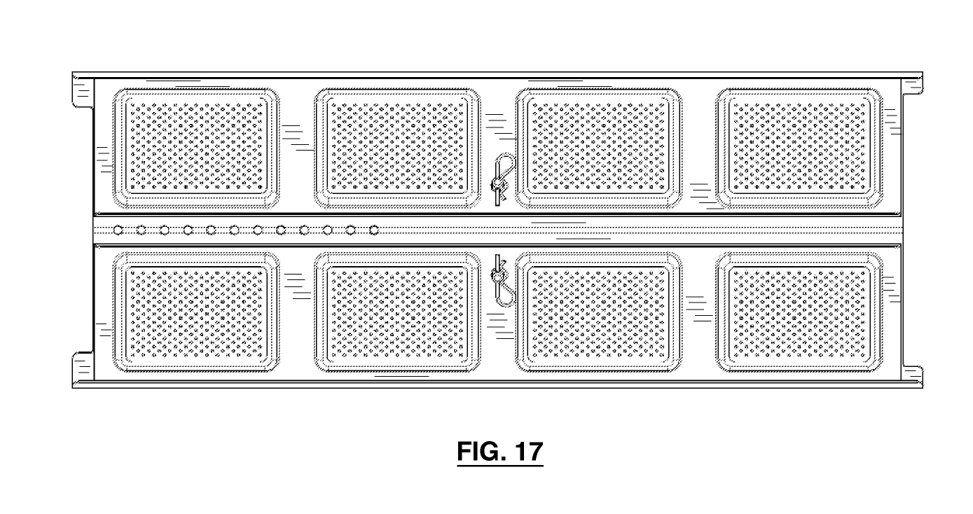

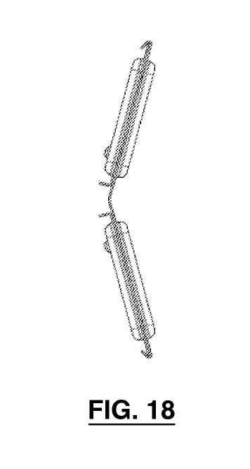

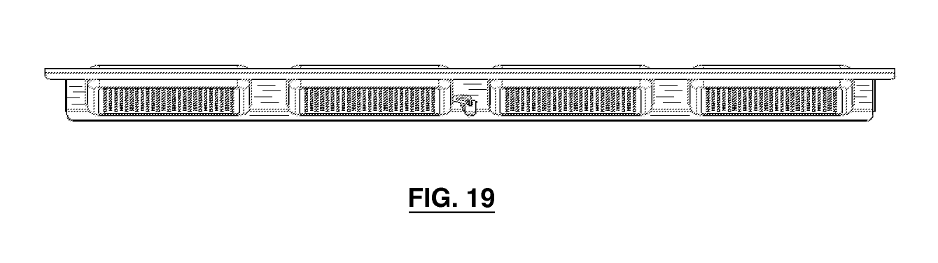

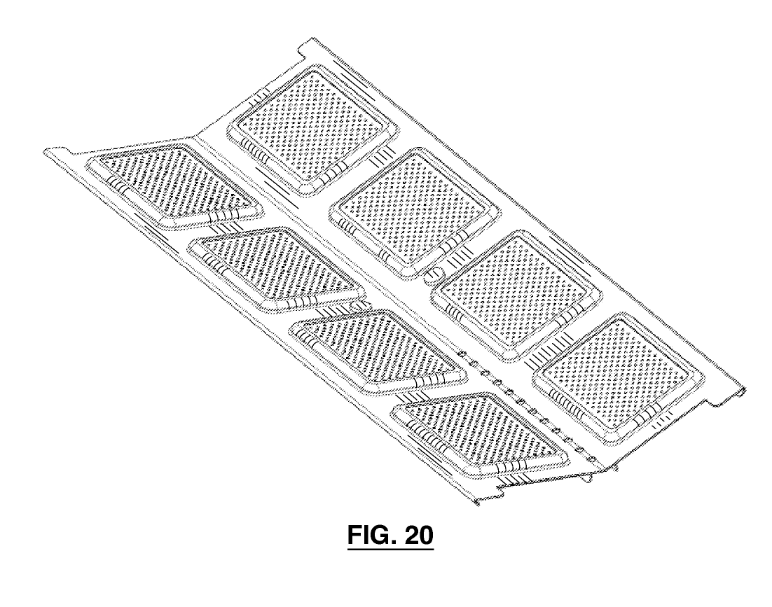

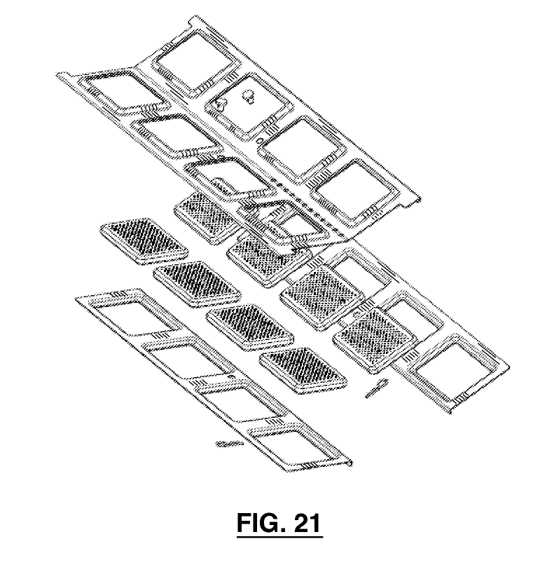

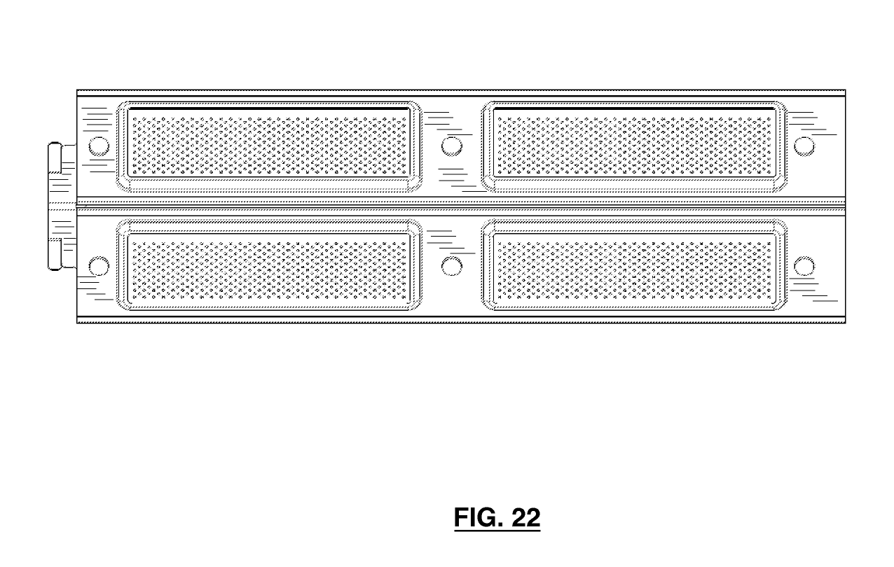

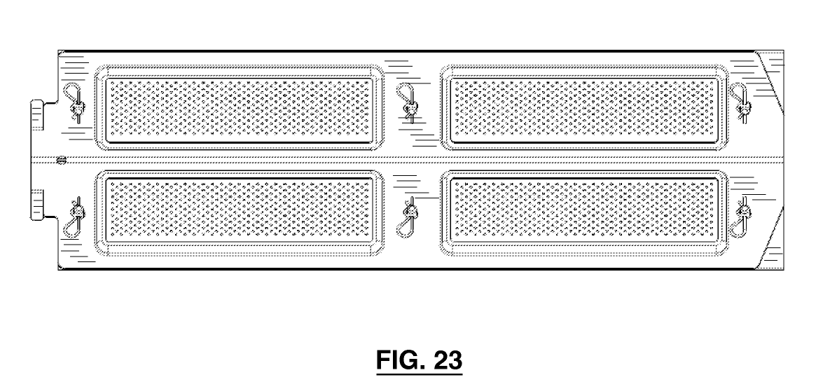

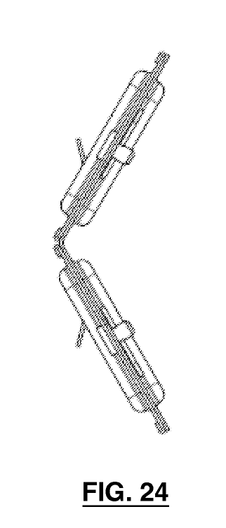

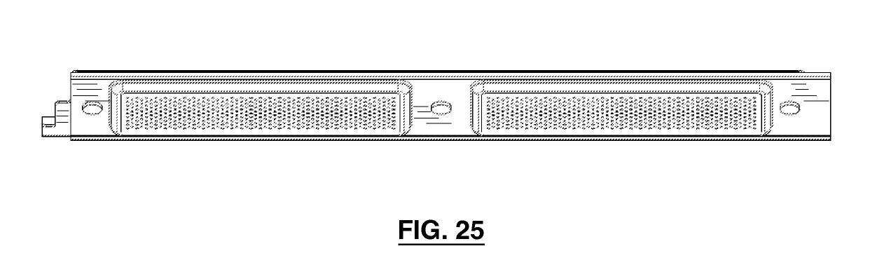

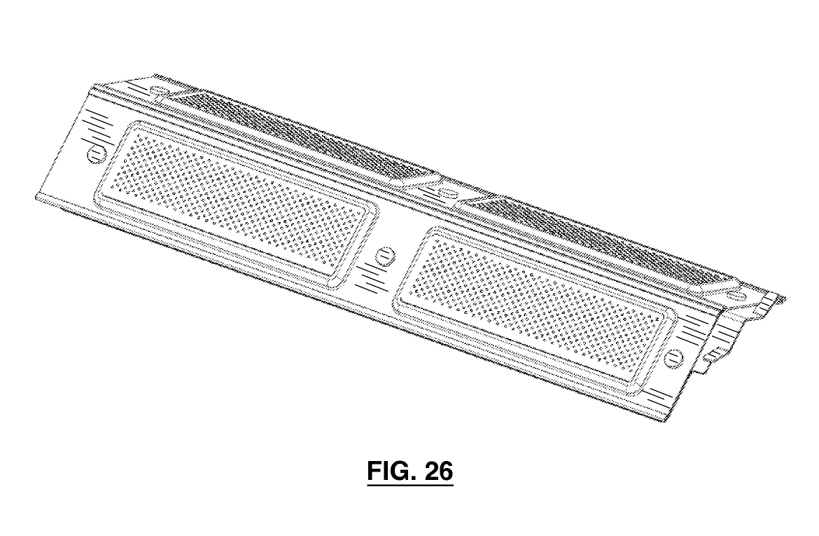

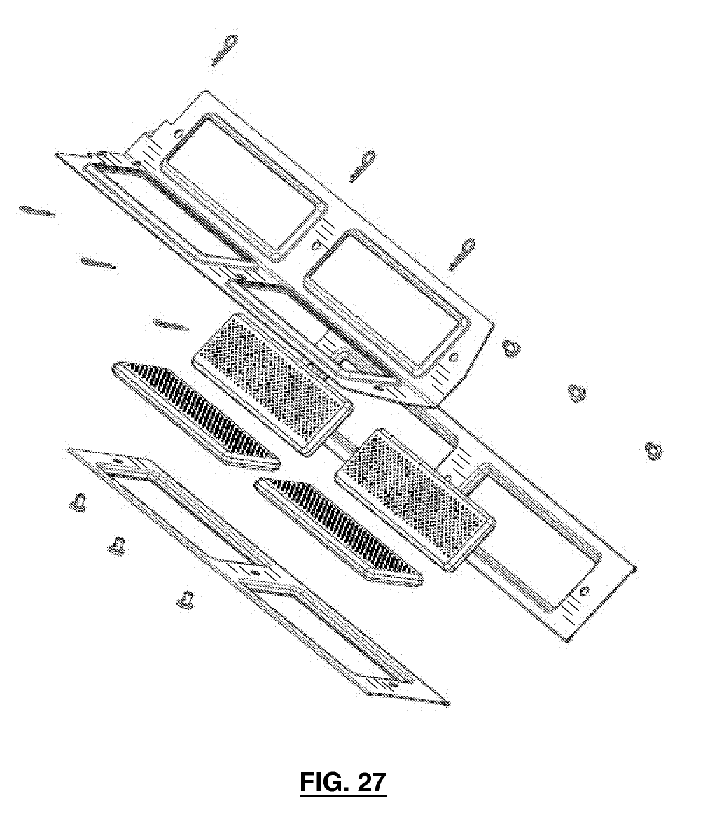

Referring now to FIG. 2, an exemplary heat plate assembly (102) is shown in greater detail in exploded bottom view. Additional views of similar embodiments of the heat plate assembly are shown in FIGS. 16-21 and a substantially similar embodiment in FIGS. 22-27.

The assembly (102) shown comprises a heat plate (200), one or more ceramic stones (202) and one or more retainers (204). The heat plate (200) is a V-shaped plate (it is shown upside down relative to the position it would be used during cooking), preferably formed from stainless steel or other suitable material, with a plurality of apertures (206) disposed therethrough. The apertures (206) form housings. The exposed aperture, once a stone (202) is disposed in the housing, is preferably slightly smaller in length and width than the stone (202) to reduce or eliminate any air gap between the heat plate (200) and the stones (202), to reduce flare-up, which will be described further below. This can typically be achieved by a set of flanges (210), walls, or the like, formed into the plate, the retainer, or both, which wrap around a portion of an exposed surface of the stone.

The one or more retainers (204) are suitable for removably retaining the one or more ceramic stones (202) to the heat plates (200) when in place. Eight stones are shown in FIGS. 2 and 16-21 while 4 stones are shown in FIGS. 22-27. The retainers are fastened to the heat plate by a fastener (not shown in FIG. 2), which may comprise clips, screws, magnets, ties, cotter pin (as shown in FIGS. 16-27) or any other suitable fastener.

In an embodiment, the retainers (204) comprise apertures matching those of the heat plate (200) such that each ceramic stone (202) has upper and lower exposed surfaces when held in the housing formed by the heat plate aperture (206) and the retainer (204). The retainer (204) shown in FIG. 2 comprises a plurality of apertures (208) matching those of the heat plate (200) to essentially sandwich each stone, however such a design is not strictly required.

Preferably, the retainers are sufficiently dimensioned and sufficiently strongly fastened to the heat plate (200) to permit the heat plate assembly (102) to be disposed in upside-down orientation within the barbecue (100) (i.e., rotated so the apex of the plate points upward), which is useful for cleaning the stones (202), without the stones (202) falling out of the assembly (100).

Due to the V-shaped profile of the heat plate (200) and the design of the apertures (206), the ceramic stones (202), when assembled, are held in coplanar arrangement relative to the heat plate (200). In other words, when the heat plate assembly (102) is disposed within the barbecue, the ceramic stones are angled relative to the cooking surface above.

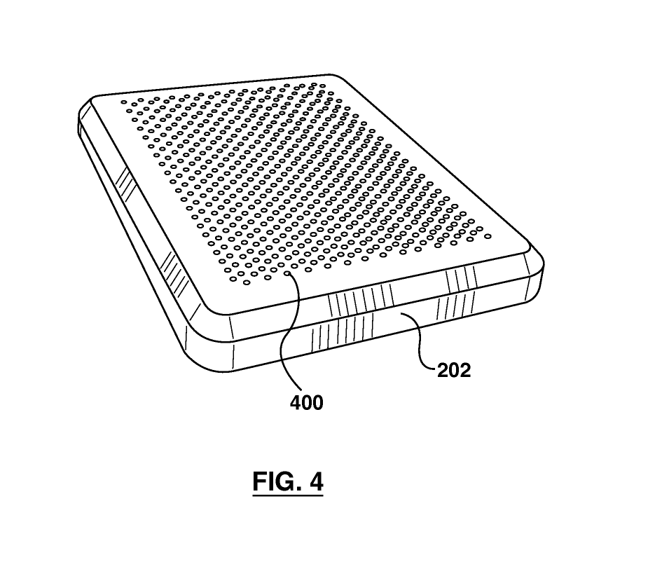

Referring now to FIG. 4, an exemplary ceramic stone (202) is shown. The ceramic stone is preferably a ported stone; that is, it comprises a plurality of small perforations (400) disposed part-way or fully through the stone. Ported stone, relative to a solid stone, permits quicker and more efficient heating. Efficiency is increased as more heat passes through the stone while also permitting the stone to heat up and radiate heat.

With reference to the above-described embodiment of the heat plate assembly, various benefits of the assembly are now described. As previously seen in FIG. 3, the heat plate assembly (102) is disposed above the barbecue's heating element (302) and beneath the barbecue's cooking surface (300). When in use for cooking (as opposed to cleaning), the V-shaped heat plate assembly (102) is disposed in the barbecue such that the apex (304) of the V-shape points downward toward the heating element. This is generally the opposite approach taken in most existing barbecue heat plates.

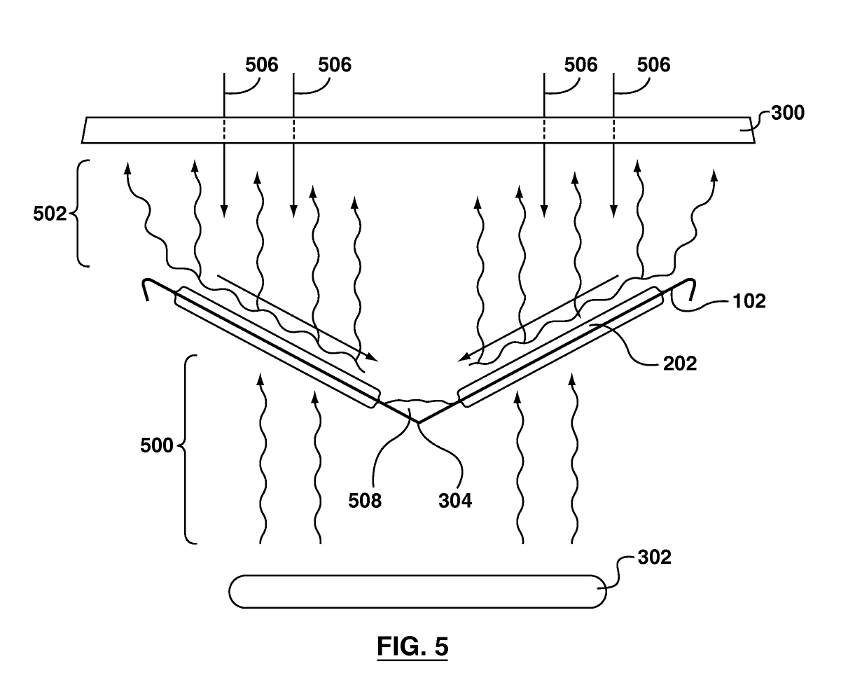

Referring now to FIG. 5, because the heat plate assembly (102) enables the ceramic stones (202) to be disposed substantially co-planar with the V-shaped heat plate (200) and therefore angled relative to the cooking surface (300), applicant has found that it is possible to increase the even distribution of heat while also reducing flare-ups.

When heat (500, depicted by the upward facing arrows in FIG. 5) is produced by the heating element (302), it rises and heats the ceramic stones (202). As mentioned previously, the ceramic stones (202) are preferably ported to permit quicker and more efficient heating. During and after heating, the ceramic stones re-emit absorbed heat upward (502) and outward along their surface as the heated air (initially closer to the apex which is heated by both ceramic stones) will tend to distribute to less heated air space (toward the outer edges of the heat plate). The heat (502) is therefore carried along the surface of the heat plate assembly (102) outward from the apex (304) of the heat plate (200), also rising toward the cooking surface (300). Essentially, the angled orientation of the ceramic stones (202) enables the heat to dissipate outward from the apex (304) of the heat plate (200), providing substantially even distribution of heat along the cooking surface (300).

Further, as food (not shown) on the cooking surface is being heated, it will tend to drip grease (506, depicted by the downward facing arrows) down to the heat plate (200). In many existing heat plates, the grease will either contact the heat plate and run off its edges (as those heat plates are generally an upside-down V-shape) to the heating element or drip past the heat plates (which are typically narrow) and contact the heating element directly. In either case, upon grease contacting the heating element, a flare-up occurs, which is disadvantageous for even heat distribution and cooking control in general (the flame often contacts the food).

Due to the V-shape of the heat plate assembly (102), dripping grease (506) is caught in the apex (304) of the heat plate assembly, which acts as a collection area (508) to collect grease for the duration of cooking. Further, since the heat plate apertures (206) are smaller than the ceramic stones (202), little to no grease penetrates the space between the ceramic stones (202) and the heat plate (200) to drip down into contact with the heating element (302) during cooking.

Once cooking has been completed, the ceramic stones (202) may be soiled and the heat plate (200) may have collected significant grease in the collection area (508). Since the stones (202) are retained by the retainer (204), the entire heat plate assembly (102) can be removed or rotated, disposed upside down within the barbecue (100), and exposed to heat (preferably high heat) to initiate a self-cleaning process. The grease will melt off and drip into the barbecue (100), and the drippings will burn away.

In accordance with the above, several embodiments of the heat plate assembly are now described.

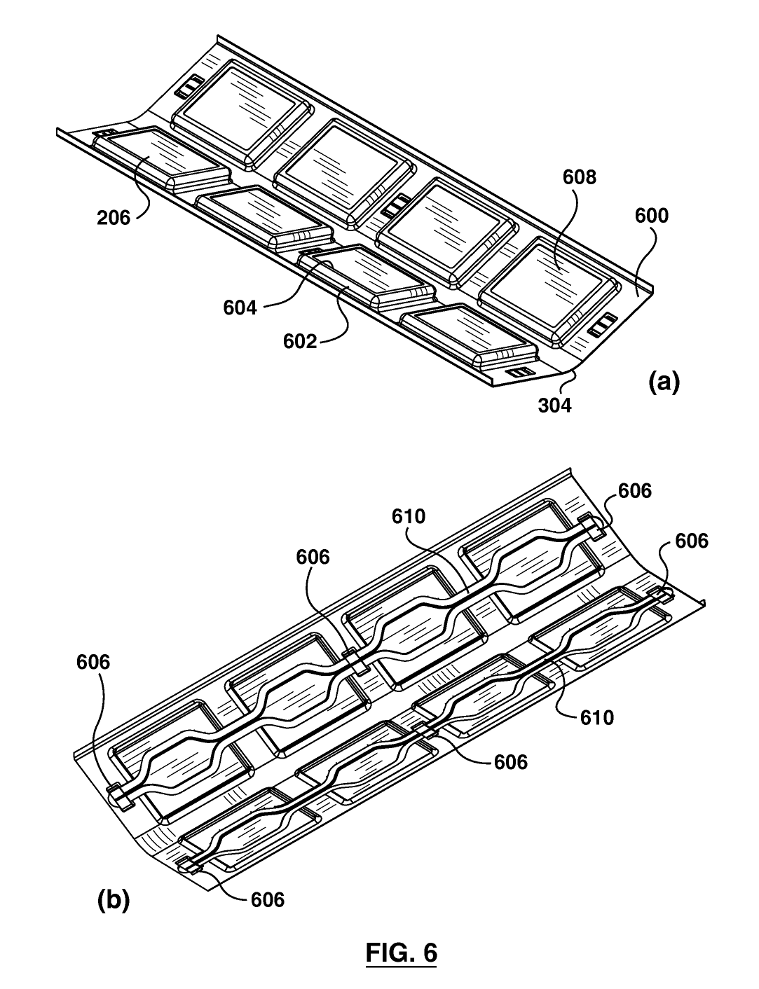

FIG. 6 shows an embodiment of the heat plate (600) having one row of four apertures to either side of the apex (304). Along the upper surface of the heat place, each aperture is formed by a peripheral side wall (602) and corresponding top flange (604) that act as a housing (608) for a respective ceramic stone. Along the lower surface of the heat plate is a plurality of retainer clips (606). The retainer clips fasten a generally longitudinal retainer (610) along the lower surface of the heat plate to retain the ceramic stones in place within the housing (608). In the embodiment shown, two similar retainers (610) are shown, one to each side of the apex (304). The retainers (610) are generally flat and wider at points of contact to the ceramic stones, while being narrower therebetween. At least some of the narrower portions are held by the clips (606).

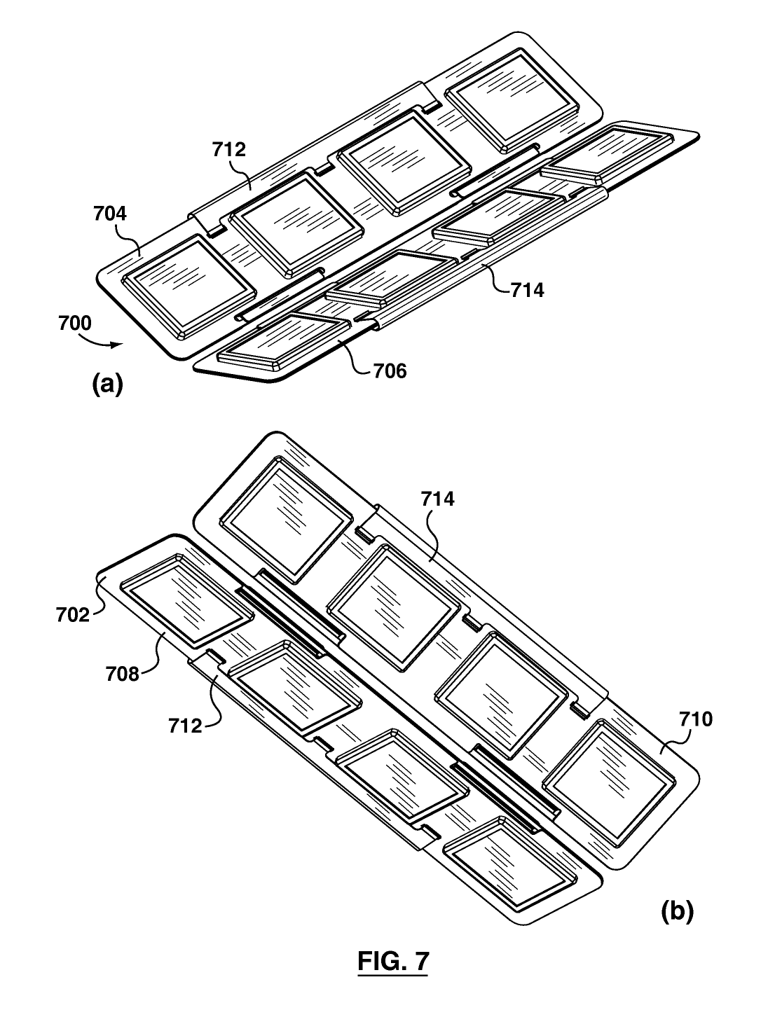

FIG. 7 shows an embodiment wherein the heat plate (700) and retainer (702) are substantially similar to one another. The heat plate comprises two separate plates (704, 706) and does not have the apex previously described. Each heat plate (704, 706) is mated to a corresponding retainer (708, 710) by a respective clip (712, 714). The clips (712, 714) fasten to the heat plate and retainer using a friction fit, for example. In this embodiment, grease is permitted to drip between the plates (704, 706), so preferably, this embodiment would be used only where the heating element (302) does not have a central gas output (such as in FIG. 3, where gas is output along two lengths that are offset from its centre), so that the grease does not cause flare ups.

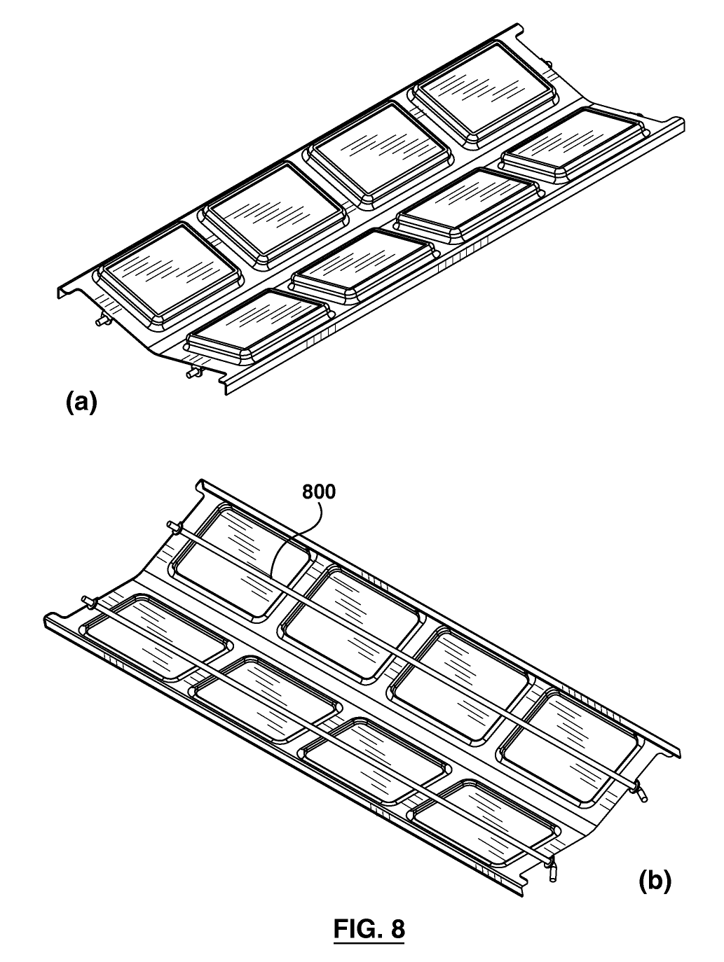

FIG. 8 shows an embodiment substantially similar to that of FIG. 6. In this embodiment, however, each retainer (800) is a rod of substantially uniform cross-section.

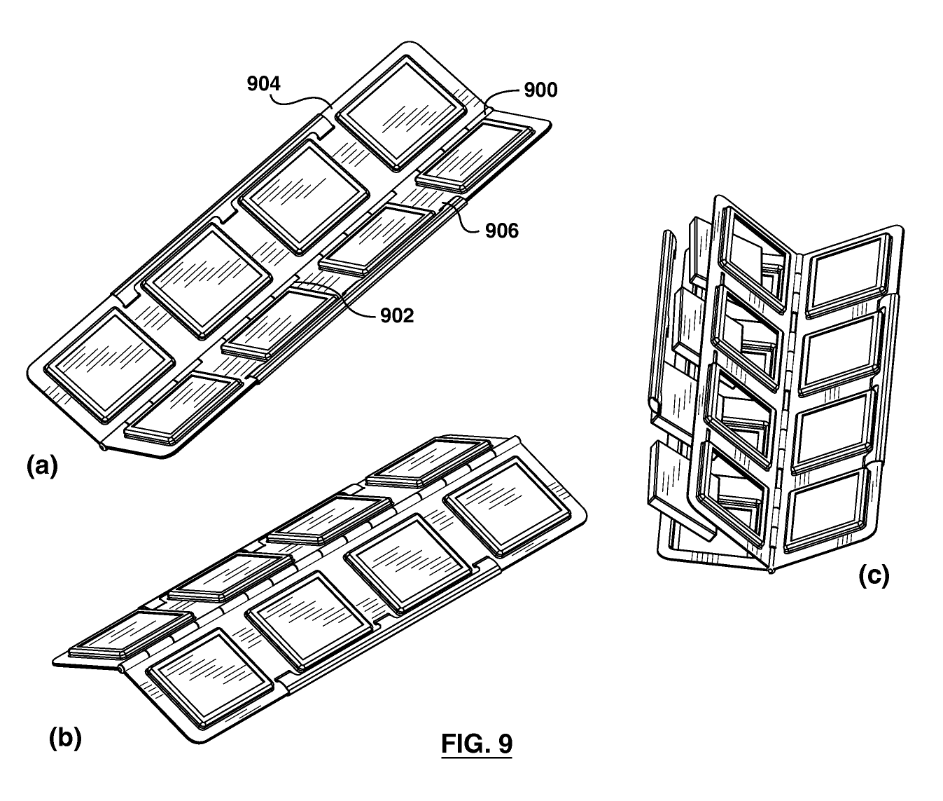

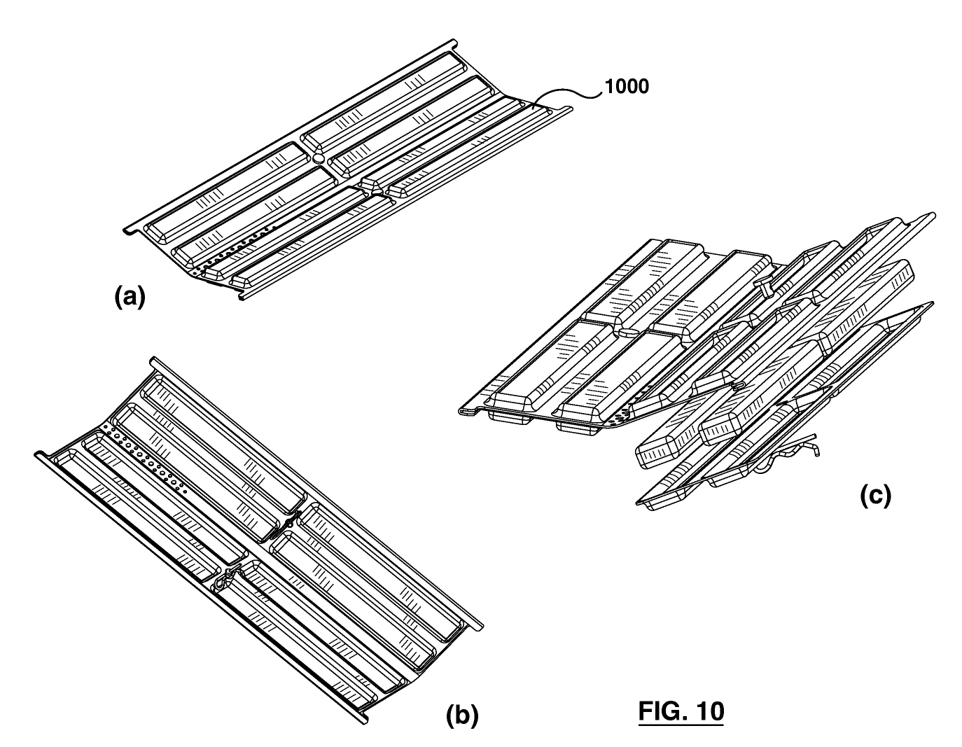

FIG. 9 shows an embodiment wherein the apex (900) is formed by a hinge (902) such that the two halves (904, 906) of the heat plate are hingedly rotatable about the apex (900) from an angle forming a V in one extent to an opposing V in the other extent. This arrangement permits double sided use. Any of the foregoing retainer systems could be provided.

FIG. 10 shows an embodiment in which the ceramic stones are elongated and the heat plate correspondingly has elongate apertures (1000) disposed therethrough. The housing style shown in FIG. 6 is shown, though it will be appreciated other arrangement are possible. Similarly, any suitable retainer arrangement may be used.

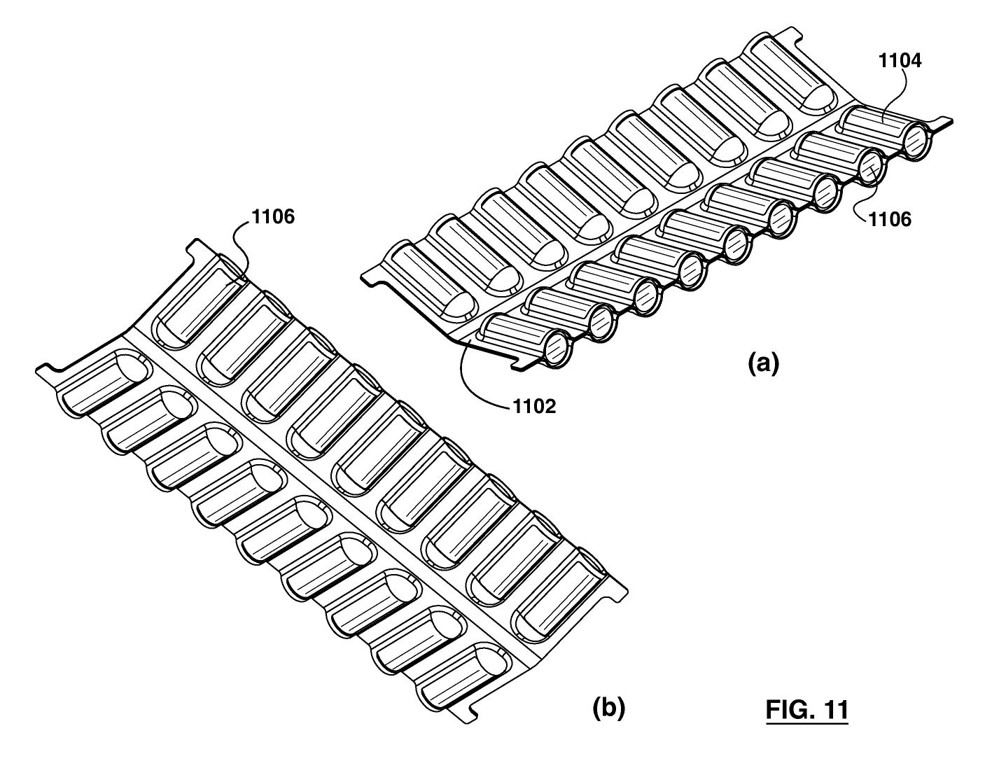

FIG. 11 shows a further alternative wherein the ceramic stones are rods and are side loaded into housings (1100) accessible along the outer edges of the heat plate (1102). Apertures (1104, 1106) are provided along the top and bottom surfaces of the heat plate. During cooking, a retainer may not be needed as the ceramic rods would be maintained in place by gravity. However, a retainer may be provided, particularly to enable the self-cleaning feature.

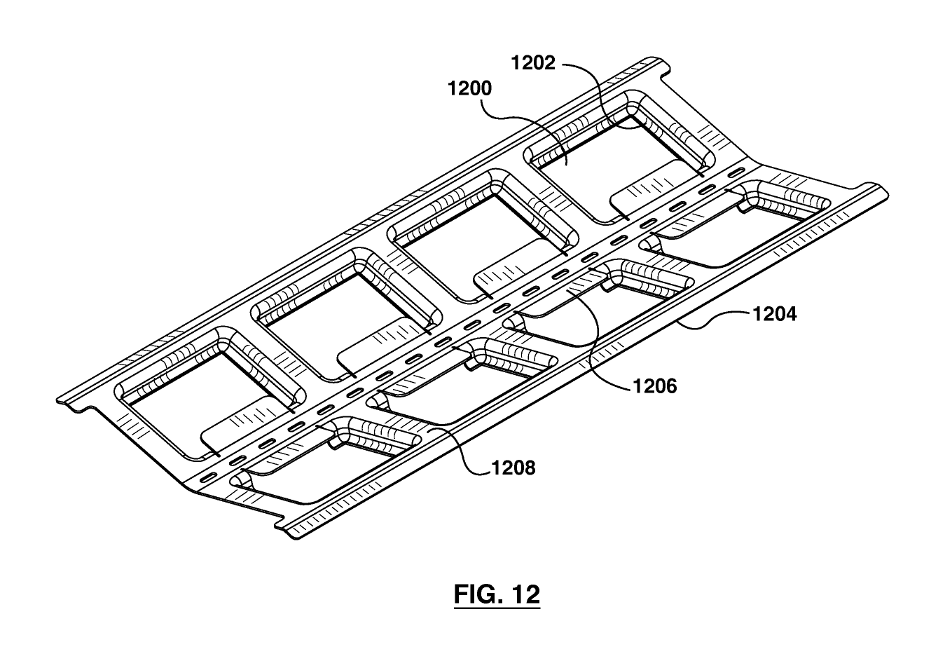

FIG. 12 shows an embodiment wherein each aperture (1200) has the housing (1202) similar to that of FIG. 6, but in this embodiment along its lower surface (1204), and a flange (1206) extending into the aperture (1200) from the apex along its upper surface (1208). A ceramic stone can be placed into the housing (1202) and held in place by the flange (1206). Preferably, the area of the aperture along the lower surface not covered by the flange is just large enough to permit insertion and removal of the ceramic stone while not permitting the ceramic stone to easily fall out of the housing without external force being applied (e.g., when the assembly is disposed upside-down for cleaning).

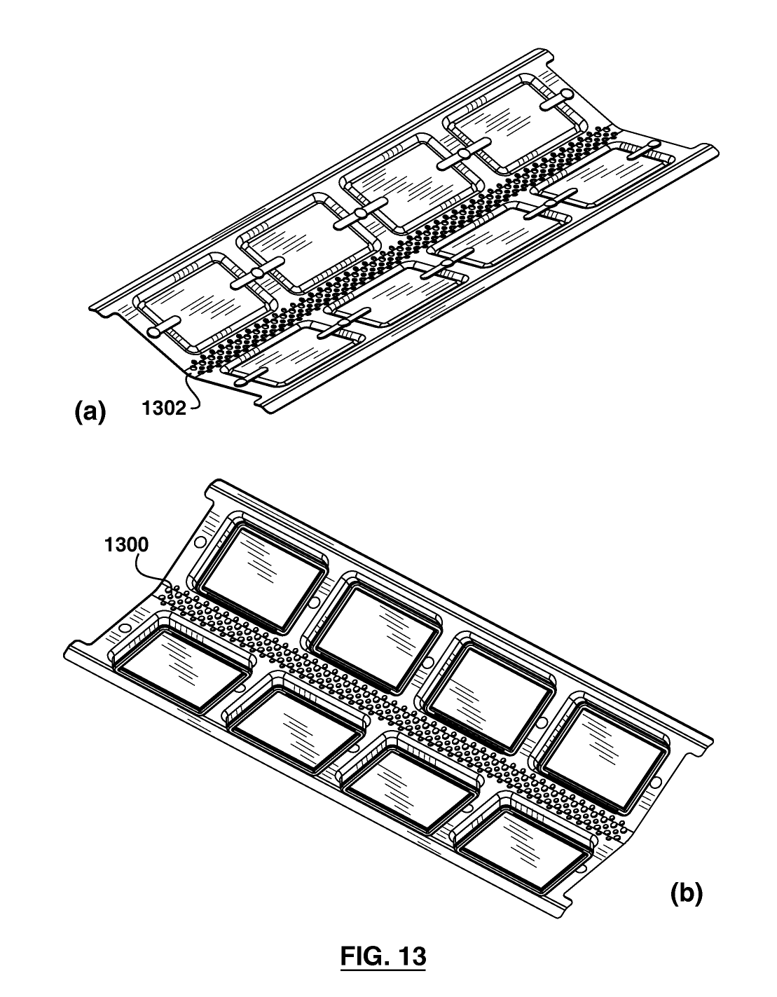

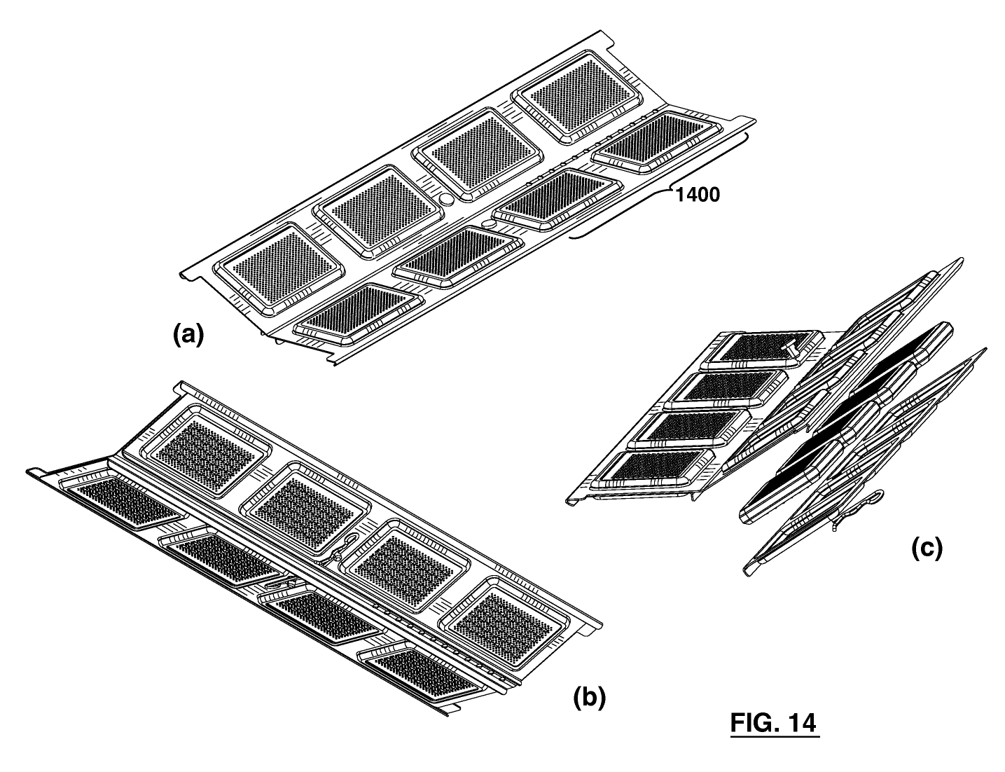

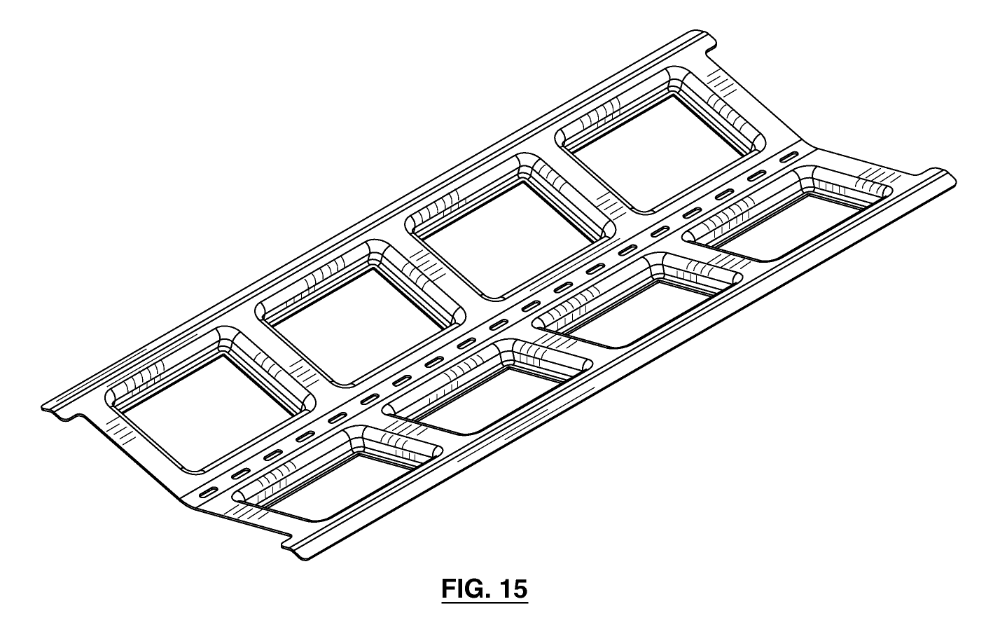

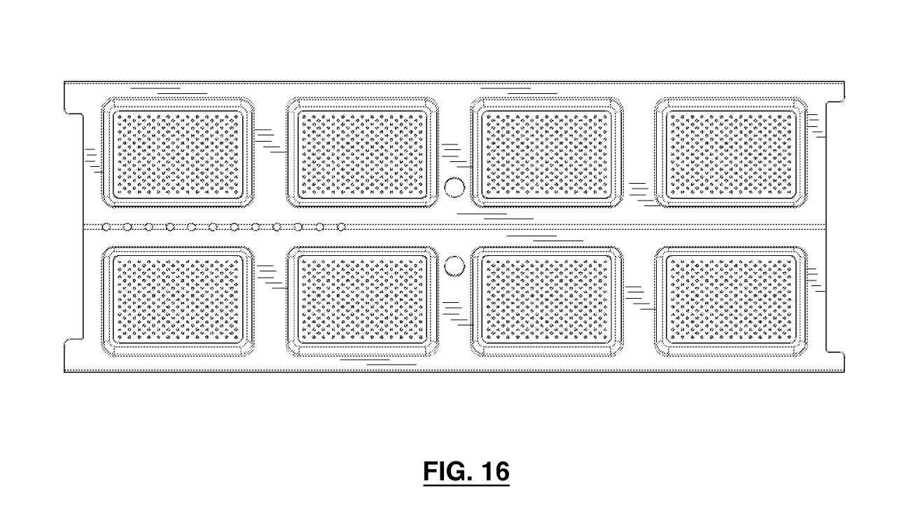

Referring now to FIGS. 13, 14 and 15, an alternative embodiment compatible with any of the foregoing is shown. In this embodiment, grease draining ports (1300) are disposed along the apex (1302). The ports (1300) may be disposed along the entire length of the apex (1302) or a portion thereof. Generally, it may be advantageous to dispose the ports (1300) along one end (1400) of the heat plate if the heat plate is to be used at an angle (longitudinally) in the barbecue, as grease will run longitudinally along the apex due to gravity toward the ports in that case. The ports are preferably on the lower end. Preferably, the ports are used where the heating element (302) does not have a central gas output (such as in FIG. 3, where gas is output along two lengths offset from its centre), so that the grease does not cause flare ups.

The ports are also depicted in FIGS. 16, 17 and 20.

Several embodiments of a heat plate assembly have now been described. It will be appreciated that the particular number, shape, orientation, symmetry or other aspect of the apertures and stones are not intended to be limiting in any respect.

It will be appreciated that the heat plate assembly may further comprise a mounting mechanism being any suitable mechanism for the particular heat plate embodiment and, where appropriate, enabling the heat plate assembly to be rotated or removed and positioned upside down for self-cleaning.

We claim:

1. A heat plate assembly for a barbecue, the heat plate assembly comprising a heat plate having one or more apertures disposed therethrough, each aperture adapted to form a housing for a heat distribution element, and a retainer detachably fastenable to the heat plate to maintain the heat distribution element in the housing, the heat plate having a generally V-shaped profile and the heat distribution element, when housed in the housing, being substantially co-planar with the heat plate, the heat plate disposable within a barbecue such that the apex of the V-shaped profile is disposed towards a heating element of the barbecue.

2. The heat plate assembly of claim 1, wherein the heat distribution element is retained in coplanar arrangement with the heat plate.

3. The heat plate assembly of claim 1, wherein the aperture of the heat plate slightly smaller in length and width than the heat distribution element to reduce or eliminate any air gap between the heat plate and the heat distribution element.

4. The heat plate assembly of claim 1, wherein the heat distribution element is a ceramic stone.

5. The heat plate assembly of claim 4, wherein the ceramic stone is ported.

6. The heat plate assembly of clam 1, wherein the retainer is detachably fastened to the heat plate by a fastener comprising one or more of clips, screws, magnets, ties, and a cotter pin.

7. The heat plate assembly of claim 1, wherein the retainer comprises apertures matching those of the heat plate to retain the heat distribution elements with upper and lower exposed surfaces.

8. The heat plate assembly of claim 1, wherein the retainer is fastened to the heat plate to retain to permit the heat plate assembly to be disposed in upside-down orientation within the barbecue while retaining the heat distribution elements therein.

9. The heat plate assembly of claim 2, wherein the apex of the heat plate assembly is a collection area for collecting grease during cooking.

10. The heat plate assembly of claim 1, wherein the heat plate comprises one row of four apertures to either side of the apex.

11. The heat plate assembly of claim 1, wherein the heat distribution elements are elongate.

12. The heat plate assembly of claim 1, wherein the heat distribution elements are side-loaded into housings formed by the heat plate and retainer, the housing being accessible along the edges of the heat plate.

13. The heat plate assembly of claim 12, wherein the heat distribution elements are rods.

14. The heat plate assembly of claim 2 , wherein the heat plate assembly comprises one or more grease draining ports along its apex.

15. The heat plate assembly of claim 1, wherein the heat plate assembly, when exposed to heat along a lower surface thereof, provides even distribution of heat at the cooking surface of the barbecue.
